(19) United States
(12) Patent Application Publication
(10) Pub. No.: US 2014/0040045 A1
(43) Pub. Date: Feb. 6, 2014

(54) System and Method for Consumer Image Capture and Review

(71) Applicants: Sterling E. Webb, Knoxville, TN (US); Chris Fortune, Knoxville, TN (US)

(72) Inventors: Sterling E. Webb, Knoxville, TN (US); Chris Fortune, Knoxville, TN (US)

(21) Appl. No.: 13/954,022

(22) Filed: Jul. 30, 2013

Related U.S. Application Data
(60) Provisional application No. 61/677,798, filed on Jul. 31, 2012.

(51) Int. Cl. G06Q 30/02

(52) U.S. Cl. CPC G06Q 30/0271
USPC 705/14.67

(57) ABSTRACT

A method for capturing images including: providing a consumer with an identification (ID) code contained in a machine readable medium; reading the ID code at a chosen location with a reader; capturing an image of the consumer in response to reading the ID code; transmitting the captured image to web storage; and, delivering a text message to the consumer, the text message comprising: the captured image; and information enabling the consumer to access the captured image in web storage.

### CROSS-REFERENCE TO RELATED APPLICATIONS

This application claims the benefit of provisional application Ser. No. 61/677,798 filed Jul. 31, 2012, the entirety of which is hereby incorporated herein by reference.

### FIELD OF THE INVENTION

This application relates to a method and system for making photographs of a consumer at selected venue sites and electronically providing the consumer with such photographs, wherein consumers are persons, preferably guests or patrons, at a venue employing this method and system.

### BACKGROUND

Photograph taking is a popular way to record memories and experiences and allow people to be reminded of fond memories to cherish forever. Many vacation venues employ photographers to roam and take photographs of people, later offering the photographs for sale as souvenirs. This service provides families or groups with the opportunity to capture the whole group without any one person being left out. Venues also employ other methods of capturing photographs, allowing guests to take home memories they cannot easily capture with their own cameras. For example, cameras may be mounted in a strategic position on a ride and be configured to take photographs every few seconds, capturing images of guests unaware that the camera is watching them. These cameras often capture candid expressions that cannot be captured by a person easily, and create a unique and special memory for guests to take away with them. Usually the roving photographer carries numbered paper tickets, which are given to guests when photographs are taken. The guests then use their numbered ticket to claim their photographs at designated pick up points at the end of the day.

Efforts regarding such methods and systems have led to continuing developments to improve their functionality, versatility, practicality and efficiency.

### BRIEF SUMMARY

A method for taking photographs of a consumer at selected venue sites and providing the consumers with such photographs and advertising data that is geographically relevant. The method includes the step of receiving the email address and/or mobile telephone number of a consumer who is provided with a personalized identification code in a readable medium such as a photo bracelet. Photographs of the consumer are taken at photographic site locations chosen by the consumer upon having the personalized identification code read by a reader at a photo site at the venue. The captured photographs are transmitted to a remote web storage at which the photographs are separated into groups associated with a particular identification code defining a consumer. Photographs may then be transmitted electronically, e.g. by text message, wireless communication, or the internet. The term ‘text message’ is to be understood to include messages sent via short message service (SMS), enhanced messaging service (EMS), multimedia messaging service (MMS), or similar protocols that send a message to a device or account associated with a mobile telephone number. Additionally, the consumer may access the web storage to review and download high resolution photographs memorializing a visit to a particular site. Photographs may be automatically put into a template based on the location of the photographic opportunity, such as a hypothetical XYZ waterpark. A logo of the waterpark may automatically be added on any photograph taken at a waterpark. Any photograph may have the ability to be sent to a social media website, including a website set up specifically to work with the method provided herein.

### BRIEF DESCRIPTION OF THE DRAWINGS

FIG. 1 is a schematic block diagram of an embodiment for practicing a method for consumer image capture and review.

### DETAILED DESCRIPTION

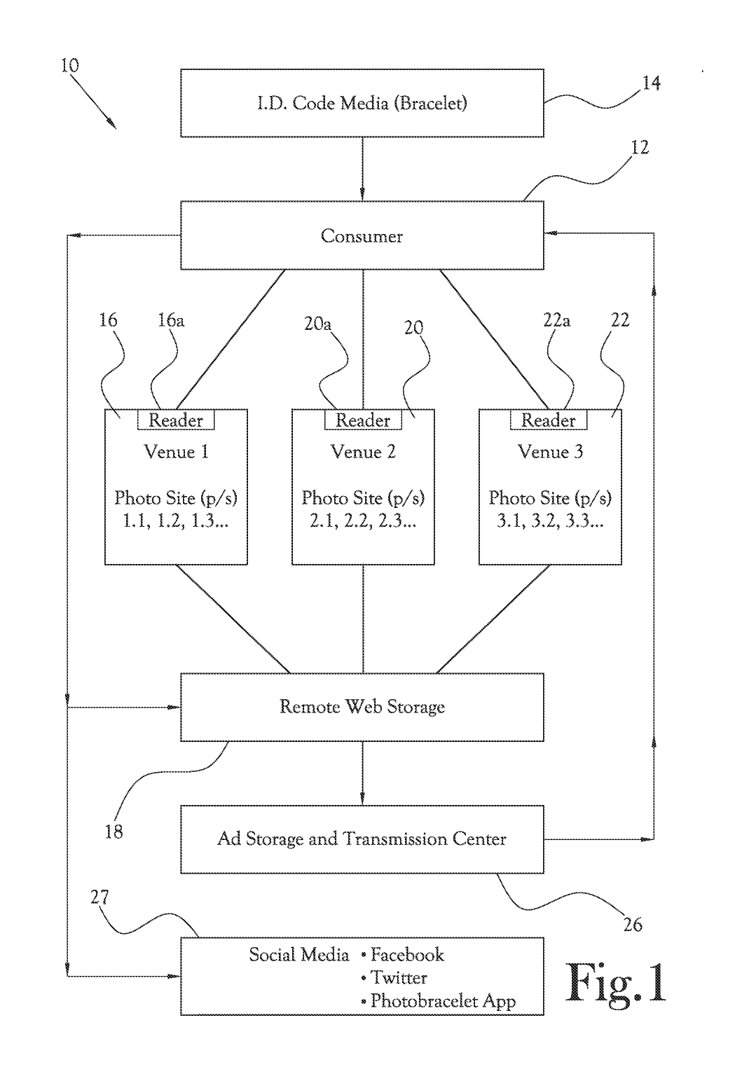

A method and system 10 for making photographs of a consumer at selected venue sites is illustrated in FIG. 1. In a step 14, a consumer may transport to different locations media or a medium on which an information bearing indicia is provided. An information bearing indicia or medium is a device or expedient that carries, or has encoded therein, machine readable information, examples of which include symbol indicia such as a bar code, a magnetic strip, an RFID instrument, biogenic information such as a fingerprint or retinal scan, etc. The transported information bearing indicia may contain information related to the customer transporting it, such as customer identification (ID).

In an embodiment, an identification code medium is provided in the form of a bracelet, referred to herein as a ‘photo bracelet’ or ‘photographic bracelet’ as is indicated in FIG. 1, or a card such as a credit card having a memory strip. The photo bracelet 14 may be sold to the consumer for a predetermined price. This price may be set and upon payment, enables the consumer to use the method shown in FIG. 1. The identification code medium may be provided in other articles or items, such as pins, rings, stickers, etc., and the term ‘photo bracelet’ shall be understood to encompass these other articles.

In an embodiment, a consumer wearing a photo bracelet 14 may select any number of venues, such as Venue 1 shown at 16, which may consist of a small attraction such as a zip line or roller coaster. The attraction may include a plurality of photo opportunity sites, also referred to as ‘photo sites’, shown at P/S 1.1 and 1.2 at the Venue 1 location. A consumer at the photo site 1.1 would enable a reader 16a, which may be positioned at each photo site, to read the information or ID on the photo bracelet 14 prior to a photograph being taken (or image being captured).

In an embodiment, the reader 16a reads the information on the bracelet automatically without the need for consumer enablement or intervention.

The reader 16a may be any device capable of reading information bearing indicia or media, such as bar code symbols, including linear, two dimensional, and matrix, and may be in the form of a scanner or imager. These media reading devices (also referred to as scanners, readers, etc.) typically read data represented by printed indicia, (also referred to as symbols, symbology, bar codes, etc.) but may also be configured to read or obtain information from an information bearing device, such as a card having a magnetic strip, a RFID instrument, biogenic or biometric information such as a fingerprint, retinal scan, etc.. In an example, the reader may be a Near Field Communication (NFC) device. Information is typically encoded into the media and read/decoded by the reader (or other system).

In an embodiment, the reader 16a, by identifying the particular consumer with the ID information coded into the media, sends or transmits read information, such as a captured photograph or image, to an electronic storage medium, such as remote or local web storage 18 or local memory such as a server with a memory storage system. Similarly, the consumer may go to a venue site shown at 20 which is labeled Venue 2. The Venue 2 location may consist of a larger attraction area than the Venue 1 location, such as a small theme park, or the like. This Venue 2 location may have a plurality of photo sites shown at P/S 2.1, 2.2, and 2.3. Other photo sites may exist or be added as desired or necessary.

A reader may be located at least one of the photo sites in Venue 2. Thus, the consumer may have their individual photo bracelet 14 read at each of the venue sites and the captured photographs are sent to web storage in a manner similar to the photograph transmissions associated with Venue 1.

In an embodiment, a type of venue location labeled Venue 3 at 22 may be a larger area such as Gatlinburg, Pigeon Forge, and Sevierville, Tenn., or an area like Branson, Mo. These areas may generally have a plurality of photo sites shown at P/S 3.1, 3.2, 3.3, etc.. In a manner similar to that described in connection with Venue 1 and Venue 2, the consumer may have a personalized photo bracelet 14 read at the reader 22a for selected photo sites, P/S 3.1, 3.2, 3.3, etc. Photographs or images captured at these venue sites may then be transmitted to the remote web storage 18 as described in connection with Venue 1 and Venue 2 photographs.

In an embodiment, the cameras at each of the venue sites may provide templates on the photographs captured. Additionally, the template may selectively include photo enhancement software, which can add elements such as guppies at an underwater attraction photo site, lightning bolts at a static electricity photo site or the like. The information on the photo templates may be included at the location of the photo site and a web address. Alternatively, photo enhancements may be further undertaken at a remote viewing site, such as website storage 18.

After a consumer has had a series of photographs taken and stored (such as in the remote web storage 18) the consumer may access these photographs for ordering purposes, viewing, altering, sending to another person or downloading to a personal account or the like.

In an embodiment, the stored photographs are viewable by the consumer utilizing remote web storage to forward or transmit a low resolution photograph to the consumer via text message. This transmission may be enabled at the time of purchase of the photo bracelet 14 by the consumer providing the seller with a mobile telephone number and/or email address.

In an embodiment, captured images in web storage include a watermark, copyright notice or other identifier until downloaded or otherwise acquired by the proper person.

In an embodiment, a consumer may access the remote web storage through the Internet and download photographs relating to the consumer's ID code input into the reader's 16a, 20a, and 22a at the time the photograph is taken.

Communication of electronic data such as images, identification information, consumer association, advertisements, payment information, fund transfers, etc. may be accomplished utilizing wired or wireless connections.

In an embodiment, at least one reader may be in communication (wired or wireless) with the internet through the use of a local or remote processor or processing system, such as might be resident on a local server or computer having a wired or wireless router for providing internet service to a device or devices such as readers or ID Code Media. The local processing system may be in communication via the internet with a remote/web server through a wired or wireless connection for the transfer of information over a distance without the use of electrical conductors or “wires”. The distances involved may be short (a few meters as in television remote control) or very long (thousands or even millions of kilometers for radio communications). Wireless communication may involve radio frequency communication. Applications may involve point-to-point communication, point-to-multipoint communication, broadcasting, cellular networks and other wireless networks. This may involve: cordless telephony such as DECT (Digital Enhanced Cordless Telecommunications); Cellular systems such as 0G, 1G, 2G, 3G or 4G; Short-range point-to-point communication such as IrDA or RFID (Radio Frequency Identification), Wireless USB, DSRC (Dedicated Short Range Communications); Wireless sensor networks such as ZigBee; Personal area networks such as Bluetooth or Ultra-wideband (UWB from WiMedia Alliance); Wireless computer networks such as Wireless Local Area Networks (WLAN), IEEE 802.11 branded as WiFi or HIPERLAN; or Wireless Metropolitan Area Networks (WMAN) and Broadband Fixed Access (BWA) such as LMDS, WiMAX or HIPERMAN.

The Internet is the worldwide, publicly accessible network of interconnected computer networks that transmit data by packet switching using a standard Internet Protocol (IP). It is a “network of networks” that consists of millions of smaller domestic, academic, business, and government networks, which together carry various information and services, such as electronic mail, online chat, file transfer, and the interlinked Web pages and other documents of the World Wide Web.

In an embodiment, one or more ads, such as coupons, are provided to the consumer 12 by an ad storage and transmission center 26. This ad storage and transmission center may include ads that the operators of venue photo sites may transmit to various consumers in their geographical area. This type of advertising should be particularly effective since the location of the consumer may be determined by the personalized identification code being read at the particular venue sites. The ad storage/transmission center 26 may be used to forward geographically relevant advertisements via text and/or email to consumers having locations identified by the photo site readers.

In an embodiment, one or more of the reader, web storage, ad storage and transmission center may be disposed in close proximity to each other, such as a singular server or a processor or processing unit.

In an embodiment, the “remote” web storage may be located locally, such as within the same venue as the reader.

From the foregoing detailed description, it may be recognized by those skilled in the art that an improved method for making photographs of a consumer at selected venue sites and providing the consumer with access to such photographs and geographically relevant advertising data may be provided. This method generates a revenue stream principally associated with the sale of photo bracelets to a consumer who provides the seller with the consumer's mobile telephone number and email address which are input into the system 10. This information allows the method 10 to have an account setup that identifies all the pictures taken in association with a particular ID code carried in media on a bracelet 14. The consumer may then be selectively provided with a text message, in low resolution, of photographs taken such that a consumer may study the photograph to assist in determining if that photograph should be downloaded in a high resolution format by accessing the remote web storage 18. Pictures may be uploaded to a selected social media location 27 such as FACEBOOK®, TWITTER® or a specific “Photobracelet” website (set up specifically to work with the method described herein) where pictures are stored and shared.

The ad storage and transmission center 26 enables the method to provide geographically pertinent advertisements, coupons, or other pertinent information to the consumer based on the location at which the consumer's photo bracelet identification code has been read. This may also be a method that may be used in connection with a social network whereby consumers using the ID code on the photo bracelet 14 may selectively place photographs made on a preselected web address such as FACEBOOK®.

As mentioned, a text message may provide the consumer with a thumbnail of photographs made within 30 seconds or so after the image was captured. If the consumer wants to see a high resolution photograph stored on the website, the consumer may gain access to the remote web storage 18 through a PDA, smartphone, portable computer or desktop computer, etc.. Then the photographs may be storaged in a high resolution format or posted on the picture wall of a related social network. It may be noted that in order for the system to operate, photo sites must each be provided with a photo bracelet reader and associated camera(s). Placement of the cameras and the photo bracelet readers at each of the photo sites may be controlled by subscribers or sponsors that participate in the process at the various venues. Such participants may also provide ads that are first preapproved and then sent to consumers in particular geographical areas.

In an embodiment an email and/or text message is sent to a consumer with information enabling the consumer to access web storage with the consumer's photographs stored therein. The enabling information may be an identifier unique for that consumer, such as a password, an internet link, an internet address, a website, a barcode, etc.

In an embodiment, a method for making photographs of a consumer at selected venue sites and providing the consumer with such photographs and advertising data includes the steps of: receiving an email address and/or mobile phone number from a consumer; providing a consumer with a personalized identification code in a readable medium; taking photographs of a consumer at selected photographic site locations chosen by the consumer by having the personalized identification code read; transmitting the photographs to a remote web storage; separating the photographs in the remote web storage into groups associated with the particular identification code of a consumer; electronically delivering to the consumer by text message photographs associated with consumer's identification code; and selectively delivering to the consumer by email and/or text message information enabling the consumer to access the web storage with the consumer's photographs stored therein. The method may include the step of delivering to the consumer email and/or text messages relating to advertisements. The method may include a personalized identification code in a readable medium contained in a photo bracelet wherein each photographic site includes a reading device for reading the identification code of each consumer choosing to use the photo site. The method may include transmitting photographs via text message to the consumer associated with a particular identification code are of low resolution to enable the consumer to preview the photograph. The method may include the step of communication between the remote web storage and the ad storage center such that geographical information concerning the consumer is provided to the ad storage center whereby advertisements related to the geographical location of the consumer are forwarded to the consumer.

In an embodiment, a method for capturing images comprises providing a consumer with an identification (ID) code contained in a machine readable medium; reading the ID code at a chosen location with a reader; capturing an image of the consumer in response to the ID code; transmitting the captured image to web storage; and delivering a text message to the consumer comprising the captured image and information enabling the consumer to access the captured image in web storage. The method may include that multiple locations are chosen. The method may include that multiple images are captured. The method may include separating captured images in web storage into groups associated with the identification code of the consumer. The method may include delivering to the consumer email and/or text messages relating to advertisements. The method may include machine readable media disposed on a bracelet worn by the consumer. The method may include converting the captured image to a lower resolution image before delivering the text message and/or email. The method may include delivering advertisements relative to the geographical location of the consumer to the consumer.

In an embodiment, a system for capturing images of a consumer comprises: a machine readable medium bearing an identification (ID) code; a reader disposed at least one chosen location for reading the ID code and capturing at least one image of the consumer in response to the ID code; a processor for transmitting the captured image to web storage and delivering a text message to the consumer, the text message comprising at least one captured image and information enabling the consumer to access at least one captured image in web storage. The system may include separating captured images in web storage into groups associated with the identification code of the consumer. The system may include delivering to the consumer an email and/or text message relating to advertisements. The system may include machine readable media disposed on a bracelet worn by the consumer. The system may include converting the captured images to a lower resolution image before delivering a text message and/or email to the consumer. The system may include delivering advertisements relative to the geographical location of the consumer to the consumer.

While the present application has illustrated and described certain embodiments in detail, it is not the intention of the applicant to restrict or in any way limit the scope of the appended claims to such detail. Additional modifications may readily appear to those skilled in the art. The claimed subject matter in its broader aspects is therefore not limited to the specific details, representative apparatus and methods, and illustrative examples shown and described. Accordingly, departures may be made from such details without departing from the spirit or scope of applicant's general concept.

1. A method for making photographs of the consumer at selected venue sites and providing the consumer with such photographs and advertising data including the steps of:
receiving an email address and/or mobile phone number from a consumer;
providing a consumer with a personalized identification code in a readable medium;
taking photographs of a consumer at selected photographic site locations chosen by a consumer by having the personalized identification code read;
transmitting the photographs to a remote web storage;
separating the photographs in the remote web storage into groups associated with the particular personalized identification code of a consumer;
electronically delivering to a consumer, by text message, photographs associated with a consumer's personalized identification code; and
selectively delivering to a consumer by email and/or text message information enabling a consumer to access the remote web storage with a consumer's photographs stored therein.

2. The method of claim 1, including the step of delivering to the consumer email and/or text messages relating to advertisements.

3. The method of claim 1, wherein the personalized identification code in a readable medium is contained within a photo bracelet and wherein each photographic site includes a reading device for reading the personalized identification code of each consumer choosing to use the photographic site.

4. The method of claim 1, wherein photographs transmitted via text message to a consumer associated with a particular personalized identification code are of low resolution to enable a consumer to preview the photograph.

5. The method of claim 1 including the step of communication between the remote web storage and an ad storage such that geographical information concerning the consumer is provided to the ad storage whereby advertisements related to the geographical location of the consumer are forwarded to the consumer.

6. A method for capturing images comprising:
providing a consumer with an identification (ID) code contained in a machine readable medium;
reading the ID code at a chosen location with a reader;
capturing an image of the consumer in response to reading the ID code;
transmitting the captured image to web storage; and,
delivering a text message to the consumer, the text message comprising:
the captured image; and
information enabling the consumer to access the captured image in web storage.

7. The method of claim 6, wherein multiple locations are chosen.

8. The method of claim 6, wherein multiple images are captured.

9. The method of claim 6, including separating the captured images in web storage into groups associated with the identification code of the consumer.

10. The method of claim 6, including delivering to the consumer email and/or text messages relating to advertisements.

11. The method of claim 6, wherein the machine readable medium is disposed on a bracelet worn by the consumer.

12. The method of claim 6, further comprising converting the captured image to a lower resolution image before delivering the text message and/or email.

13. The method of claim 6 further comprising delivering advertisements related to the geographical location of the consumer to the consumer.

14. A system for capturing images of a consumer comprising:
a machine readable medium bearing an identification (ID) code;
a reader disposed at least one chosen location for reading the ID code and capturing at least one image of the consumer in response to reading the ID code;
a processor for transmitting the captured image to web storage and delivering a text message to the consumer, the text message comprising:
at least one captured image; and
information enabling the consumer to access at least one captured image in web storage.

15. The system of claim 14, wherein multiple captured images in web storage are separated into groups associated with the identification code of the consumer.

16. The system of claim 14, wherein an email and/or text message relating to advertisements is delivered to the consumer by a transmission center.

17. The system of claim 14, wherein the machine readable medium is disposed on a bracelet worn by the consumer.

18. The system of claim 14, wherein at least one captured image is converted to a lower resolution before delivering the text message and/or email.

19. The system of claim 14 wherein advertisements related to the geographical location of the consumer are delivered to the consumer.

20. The system of claim 14 wherein captured images in web storage and/or the text message include a watermark.
